(19) United States
(12) Patent Application Publication
(10) Pub. No.: US 2017/0147249 A1
(43) Pub. Date: May 25, 2017

(54) METHOD TO ENFORCE PROPORTIONAL BANDWIDTH ALLOCATIONS FOR QUALITY OF SERVICE

(71) Applicant: QUALCOMM Incorporated, San Diego, CA (US)

(72) Inventors: Derek Robert HOWER, Durham, NC (US); Harold Wade CAIN III, Raleigh, NC (US); Carl Lan WALDSPURGER, Palo Alto, CA (US)

(21) Appl. No.: 15/192,988

(22) Filed: Jun. 24, 2016

Related U.S. Application Data
(60) Provisional application No. 62/258,826, filed on Nov. 23, 2015.

(51) Int. Cl. G06F 3/06; G06F 12/08

(52) U.S. Cl. CPC G06F 3/0631; G06F 12/084; G06F 3/0604; G06F 3/0673; G06F 2212/62

(57) ABSTRACT

Systems and methods relate to distributed allocation of bandwidth for accessing a shared memory. A memory controller which controls access to the shared memory, receives requests for bandwidth for accessing the shared memory from a plurality of requesting agents. The memory controller includes a saturation monitor to determine a saturation level of the bandwidth for accessing the shared memory. A request rate governor at each requesting agent determines a target request rate for the requesting agent based on the saturation level and a proportional bandwidth share allocated to the requesting agent, the proportional share based on a Quality of Service (QoS) class of the requesting agent.

### CROSS-REFERENCE TO RELATED APPLICATIONS

The present application for patent claims the benefit of U.S. Provisional Application No. 62/258,826, entitled “A METHOD TO ENFORCE PROPORTIONAL BANDWIDTH ALLOCATIONS FOR QUALITY OF SERVICE,” filed Nov. 23, 2015, assigned to the assignee hereof, and expressly incorporated herein by reference in its entirety.

### FIELD OF DISCLOSURE

Disclosed aspects are directed to resource allocation in a processing system. More specifically, exemplary aspects are directed to a distributed management of bandwidth allocation in a processing system.

### BACKGROUND

Some processing systems may include shared resources, such as a shared memory, shared among various consumers, such as processing elements. With advances in technology, there is an increasing trend in the number of consumers that are integrated in a processing system. However, this trend also increases competition and conflict for the shared resources. It is difficult to allocate memory bandwidth of the shared memory, for example, among the various consumers, while also guaranteeing the expected quality of service (QoS) or other performance metrics for all the consumers.

Conventional bandwidth allocation mechanisms tend to be conservative in the allocation of available memory bandwidth to the various consumers, with a view to avoiding situations wherein desired memory bandwidth is not available for timing-critical or bandwidth-sensitive applications. However, such conservative approaches may lead to underutilization of the available bandwidth. Accordingly, there is a need in the art for improved allocation of available memory bandwidth.

### SUMMARY

Exemplary aspects of the invention are directed to systems and method for relate to distributed allocation of bandwidth for accessing a shared memory. A memory controller which controls access to the shared memory, receives requests for bandwidth for accessing the shared memory from a plurality of requesting agents. The memory controller includes a saturation monitor to determine a saturation level of the bandwidth for accessing the shared memory. A request rate governor at each requesting agent determines a target request rate for the requesting agent based on the saturation level and a proportional bandwidth share allocated to the requesting agent, the proportional share based on a Quality of Service (QoS) class of the requesting agent.

For example, an exemplary aspect is directed to a method distributed allocation of bandwidth, the method comprising: requesting bandwidth for accessing a shared memory, by a plurality of requesting agents, determining a saturation level of the bandwidth for accessing the shared memory in a memory controller for controlling access to the shared memory, and determining target request rates at each requesting agent based on the saturation level and proportional bandwidth share allocated to the requesting agent based on a Quality of Service (QoS) class of the requesting agent.

Another exemplary aspect is directed to an apparatus comprising: a shared memory, a plurality of requesting agents configured to request access to the shared memory and a memory controller configured to control access to the shared memory, wherein the memory controller comprises a saturation monitor configured to determine a saturation level of bandwidth for access to the shared memory. The apparatus also comprise a request rate governor configured to determine a target request rate at each requesting agent based on the saturation level and a proportional bandwidth share allocated to the requesting agent based on a Quality of Service (QoS) class of the requesting agent.

Another exemplary aspect is directed to an apparatus comprising: means requesting bandwidth for accessing a shared memory, means for controlling access to the shared memory comprising means for determining a saturation level of the bandwidth for accessing the shared memory, and means for determining a target request rate at each means for requesting based on the saturation level and a proportional bandwidth share allocated to the means for requesting agent based on a Quality of Service (QoS) class of the means for requesting.

Yet another exemplary aspect is directed to a non-transitory computer readable storage medium comprising code, which, when executed by a processor, cause the processor to perform operations for distributed allocation of bandwidth, the non-transitory computer readable storage medium comprising code for requesting bandwidth for accessing a shared memory, by a plurality of requesting agents, code for determining a saturation level of the bandwidth for accessing the shared memory, at a memory controller for controlling access to the shared memory, and code for determining target request rates at each requesting agent based on the saturation level and proportional bandwidth share allocated to the requesting agent based on a Quality of Service (QoS) class of the requesting agent.

### BRIEF DESCRIPTION OF THE DRAWINGS

The accompanying drawings are presented to aid in the description of aspects of the invention and are provided solely for illustration of the aspects and not limitation thereof.

FIG. 1 illustrates one arrangement in one exemplary proportional bandwidth allocation system according to aspects of this disclosure.

FIGS. 2A-B illustrate logical flows in exemplary multiple phase throttling implementations in a proportional bandwidth allocation according to aspects of this disclosure.

FIG. 2C shows pseudo code algorithms for exemplary operations in the initialization phase block of FIG. 2B.

FIGS. 3A-B show pseudo code algorithms for exemplary operations in the rapid throttling phase blocks of FIGS. 2A-B, respectively.

FIGS. 4A-B show pseudo code algorithms for exemplary operations in an exponential decrease process of FIGS. 3A-B, respectively.

FIGS. 5A-B show pseudo code algorithms for exemplary operations in the fast recovery phase blocks of FIGS. 2A-B, respectively.

FIGS. 6A-B show pseudo code algorithms for exemplary operations in an iterative search process of FIGS. 5A-B, respectively.

FIGS. 7A-B show pseudo code algorithms for exemplary operations in the active increase phase blocks of FIG. 2A-B, respectively.

FIGS. 8A-B show pseudo code algorithms for exemplary operations in a rate increase process of FIGS. 7A-B, respectively.

FIGS. 9A-B show pseudo code algorithms for exemplary operations in a rate rollback process of FIGS. 7A-B, respectively.

FIGS. 10A-B show pseudo code algorithms for exemplary operations in the reset confirmation phase block of FIGS. 2A-B, respectively.

FIG. 11 shows a timing simulation of events in a multiple phase throttling process in a proportional bandwidth allocation according to aspects of this disclosure.

FIG. 12 shows an exemplary request rate governor in a proportional bandwidth allocation system according to aspects of this disclosure.

FIG. 13 illustrates one configuration of a shared second level cache arrangement, in one exemplary proportional bandwidth allocation system according to aspects of this disclosure.

FIG. 14 illustrates an exemplary method of bandwidth allocation according to aspects of this disclosure.

FIG. 15 illustrates an exemplary wireless device in which one or more aspects of the disclosure may be advantageously employed.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a,” “an,” and “the” are intended to include the plural forms as well, unless the context clearly indicates otherwise. It will be further understood that the terms “comprises”, “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Exemplary aspects of this disclosure are directed to processing systems comprising at least one shared resource such as a shared memory, shared among two or more consumers or requesting agents of the shared resource. In one example, the requesting agents can be processors, caches, or other agents which may access the shared memory. The requests may be forwarded to a memory controller which controls access to the shared memory. In some instances, the requesting agents may also be referred to as sources from which requests are generated or forwarded to the memory controller. The requesting agents may be grouped into classes with a Quality of Service (QoS) associated with each class.

According to exemplary aspects, bandwidth for the shared memory may be allocated in units of proportional shares of the total bandwidth to each QoS class, such that the bandwidth for each QoS class is sufficient to at least satisfy the QoS metrics for that QoS class. The parameter βᵢ, where the “i” index identifies a QoS class to which a requesting agent belongs, is referred to as a “proportional share weight” for the QoS class (in other words, the proportional share weight indicates the proportional share of the bandwidth assigned to the agent based on the respective QoS of the class to which the agent belongs). In correspondence to the proportional share weight βᵢ per class, a parameter αᵢ is also defined per class, wherein for a QoS class identified by “i”, αᵢ is referred to as a “proportional share stride” for the QoS class. In exemplary aspects, the proportional share stride αᵢ of a QoS class is the inverse of the proportional share weight βᵢ of the QoS class. The proportional share stride αᵢ of the QoS class is representative of a relative cost of servicing a request from the QoS class.

When excess bandwidth is available, one or more QoS classes may be allotted the excess bandwidth, once again in proportion, based on the respective proportional share parameters αᵢ or βᵢ of the QoS classes. Exemplary aspects of proportional bandwidth distribution are designed to guarantee the QoS for each class, while avoiding problems of underutilization of excess bandwidth.

In an aspect, a saturation monitor can be associated with the memory controller for the shared resource or shared memory. The saturation monitor can be configured to output a saturation signal indicating one or more levels of saturation. The saturation level may provide an indication of the number of outstanding requests to be serviced during a given interval of time, and can be measured in various ways, including, for example, based on a count of the number of requests in an incoming queue waiting to be scheduled by the memory controller for accessing the shared memory, a number of requests which are denied access or are rejected from being scheduled for access to the shared resource due to lack of bandwidth, etc. The given interval may be referred to as an epoch, and can be measured in units of time, e.g., microseconds, or a number of clock cycles, for example. The length of the epoch can be application specific. The saturation monitor can output a saturation signal at one of one or more levels, for example, to indicate an unsaturated state, and one or more levels such as a low, medium, or high saturated states of the shared resource.

At each requesting agent, a governor is provided, to adjust the rate at which requests are generated from the agent, based on the saturation signal. The governors implement a governor algorithm which is distributed across the agents, in the sense that at every epoch, each governor recalculates a target request rate of its corresponding requesting agent without having to communicate with other governors of other requesting agents. In exemplary aspects, each governor can calculate the target request rate of its respective requesting agent based on knowledge of the epoch boundaries and the saturation signal, without communication with the other requesting agents.

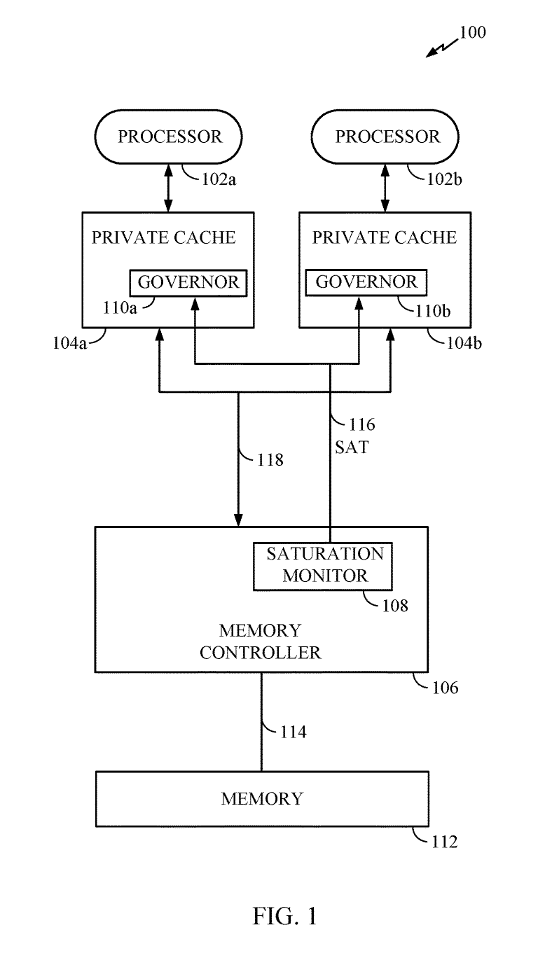

With reference now to FIG. 1 an example processing system 100 configured according to exemplary aspects is shown. Processing system 100 may have one or more processors, of which two processors are representatively illustrated as processors 102a-b. Processors 102a-b may have one or more levels of caches including private caches, of which private caches 104a-b (e.g., level 1 or “L1” caches) for respective processors 102a-b are shown. While private caches 104a-b can communicate with other caches including shared caches (not shown), in the illustrated example, private caches 104a-b are shown to communicate with memory controller 106. Memory controller 106 may manage accesses to memory 112, wherein memory 112 may be a shared resource. Memory 112 may be a hard drive or main memory as known in the art, and may be located off-chip, i.e., integrated on a different die or chip from the one which integrates the rest of processing system 100 shown in FIG. 1 (including, for example, processors 102a-b, private caches 104a-b, and memory controller 106), although various alternative implementations are possible.

Each time processors 102a-b request data from private caches 104a-b, respectively, and there is a miss in the respective private caches 104a-b, the private caches 104a-b will forward the requests to memory controller 106 for the requested data to be fetched from memory 112 (e.g., in an example where the request is a read request). The requests from private caches 104a-b are also referred to as incoming memory requests from the perspective of memory controller 106. Since memory 112 may be located off-chip or even in on-chip implementations, may involve long wires/interconnects for transfer of data, the interfaces to memory 112 (e.g., interface 114) may have bandwidth restrictions which may limit the number of incoming memory requests which can be serviced at any given time. Memory controller 106 may implement queuing mechanisms (not shown specifically) for queuing the incoming memory requests before they are serviced. If the queuing mechanisms are full or saturated, some incoming memory requests may be rejected in one or more ways described below.

Memory controller 106 is shown to include saturation monitor 108, wherein saturation monitor 108 is configured to determine a saturation level. The saturation level can be determined in various ways. In one example, saturation can be based on count a number of incoming memory requests from private caches 104a-b which are rejected or sent back to a requesting source as not being accepted for servicing. In another example, the saturation level can be based on a count or number of outstanding requests which are not scheduled access to memory 112 due to unavailability of bandwidth for access to memory 112. For example, the saturation level can be based on a level of occupancy of an overflow queue maintained by memory controller 106 (not explicitly shown), wherein the overflow queue can maintain requests which cannot be immediately scheduled access to memory 112 due to unavailability of bandwidth for access to memory 112 (e.g., rather than being rejected and sent back to the requesting source). Regardless of the specific manner in which the saturation level is determined, the count (e.g., of rejections or occupancy of the overflow queue) at the end of every epoch can be compared to a pre-specified threshold. If the count is greater than or equal to the threshold, saturation monitor 108 may generate a saturation signal (shown as “SAT” in FIG. 1) to indicate saturation. If the count is less than the threshold, the SAT signal may be de-asserted or set to an unsaturated state by saturation monitor 108, to indicate there is no saturation. In some aspects, the saturation signal may also be generated in a way to show different levels of saturation, e.g., low, medium, or high saturation, for example by using a 2-bit saturating signal SAT[1:0] (not specifically shown) wherein, generating an appropriate saturation value may be based on comparison of the count to two or more thresholds indicative of the different saturation levels.

With continuing reference to FIG. 1, private caches 104a-b are shown to include associated request rate governors 110a-b. Request rate governors 110a-b are configured to enforce bandwidth allocation based, among other factors, on the saturating signal SAT generated by saturation monitor 108. Although the saturating signal SAT is shown to be directly provided to request rate governors 110a-b via the bus designated by the reference numeral 116 in FIG. 1, it will be understood that this may not imply a dedicated bus for this purpose, where in some cases, bus 116 may be combined with or be a part of the interface designated with the reference numeral 118, used for communication between private cache 104a-b and memory controller 106 (e.g., for receiving the incoming memory requests at memory controller 106 and supplying requested data to private caches 104a-b). Request rate governors 110a-b can be configured to determine a target request rate for respective private caches 104a-b. The target request rate may be a rate at which memory requests may be generated by the private caches 104a-b, wherein the target request rate may be based on the associated proportional share parameters (e.g., proportional share weight βᵢ or associated proportional share stride αᵢ, based on specific implementations) assigned to private caches 104a-b based on their associated QoS class (e.g., based on the QoS class of corresponding processors 102a-b).

In terms of the proportional share weight βᵢ, proportional bandwidth share for each requesting agent is provided by a bandwidth share weight assigned to the requesting agent divided by a sum of the bandwidth share weights assigned to each of the plurality of requesting agents. For example, the proportional share for each QoS class (or correspondingly, an agent belonging to the respective QoS class, e.g., for private caches 104a-b based on their respective QoS classes) can be expressed in terms of the assigned bandwidth share weight for the QoS class or corresponding agent, divided by the sum of the all of the respective assigned bandwidth share weights, which can be represented as shown in Equation (1) below,

$${ProportionalShare}_{i} = \begin{matrix}{β}_{i} \\ {Σ}_{∀} {β}_{j}\end{matrix} \qquad Equation ( 1 )$$

wherein, the denominator Σ_{∀}β₁ represents the sum of the bandwidth share weights for all of the QoS classes.

It is noted that the calculation of the proportional share can be simplified from Equation 1 by using the proportional share strides a, instead of the proportional share weights βᵢ. This is understood by recognizing that since a, is the inverse of βᵢ, αᵢ can be expressed as an integer, which means that division (or multiplication by a fraction) may be avoided during run time or on the fly to determine cost of servicing a request. Thus, in terms of proportional share strides a, the proportional bandwidth share for each requesting agent is provided by a bandwidth share stride assigned to the requesting agent multiplied by a sum of the bandwidth share strides assigned to each of the plurality of requesting agents.

Regardless of the specific mechanism used to calculate the respective proportional shares, request rate governors 110a-b may be configured to pace or throttle the rate at which memory requests are generated by private caches 104a-b in accordance with the target request rate. In an example, request rate governors 110a-b can be configured to adjust the target request rate by a process comprising multiple phases, e.g., four phases, in lockstep with one another, wherein the target request rate may vary based on the phase. Transitions between these phases and corresponding adjustments to the respective target request rate can occur at time intervals such as epoch boundaries. Running in lockstep can allow request rate governors 110a-b to quickly reach equilibrium such that request rates for all private caches 104a-b are in proportion to the corresponding bandwidth shares, which can lead to efficient memory bandwidth utilization. In exemplary implementations of rate adjustment based on the saturating signal SAT and request rate governors 110a-b, additional synchronizers are not required.

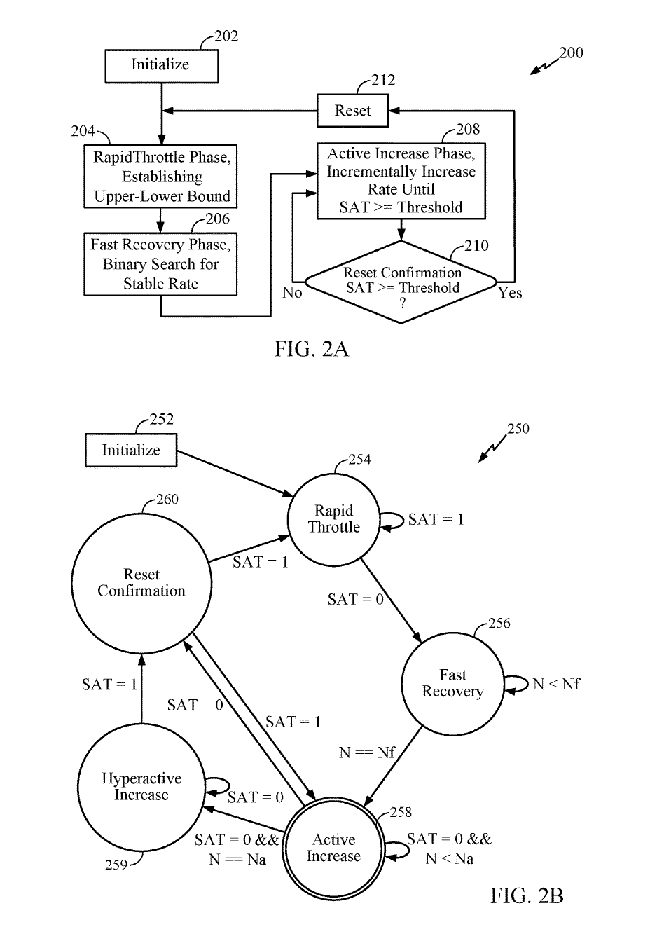

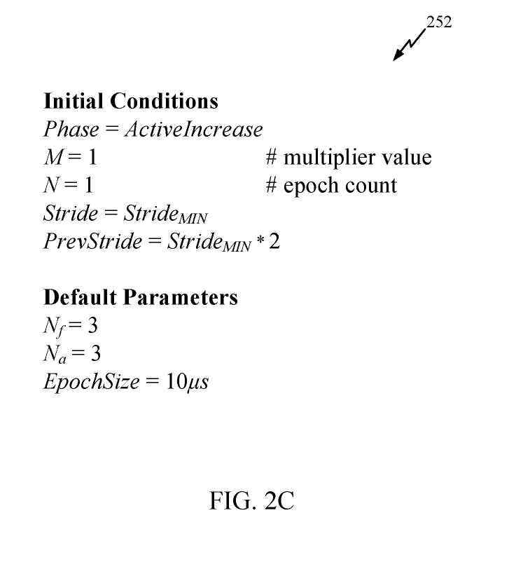

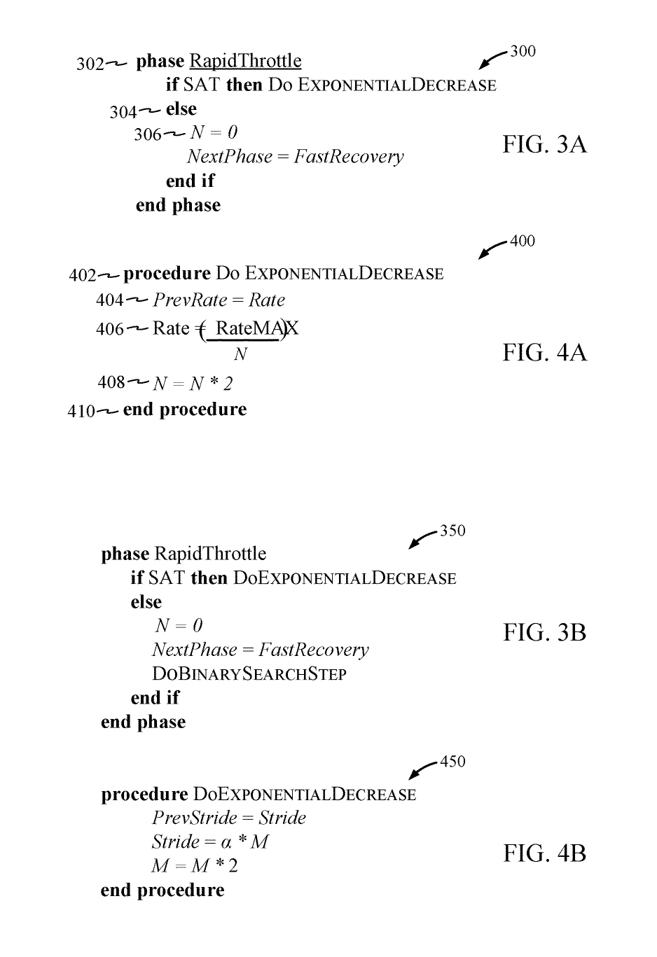

With reference now to FIGS. 2A-B, flow charts for processes 200 and 250 pertaining to transitions between the multiple phases discussed above is illustrated. The processes 200 and 250 are analogous, and while process 200 of FIG. 2A pertains to algorithms for calculating the target rate (e.g., in units of requests/cycle) using the proportional share weight βᵢ, process 250 of FIG. 2B represents algorithms for calculating the inverse of the target rate (in integer units) using the proportional share stride αᵢ (due to the inverse relationship between a, and PO. Example algorithms which may be used to implement Blocks 202-210 of process 200 shown in FIG. 2A are shown and described with relation to FIGS. 3A-10A below. Since the inverse of the target rate can be represented in integer units, the corresponding algorithms in FIGS. 3B-10B show example algorithms which may be used to implement Blocks 252-260 of process 250 shown in FIG. 2B. The implementation of the algorithms of FIGS. 3B-10B may be simpler in comparison to the implementation of their counterpart algorithms in FIGS. 3A-10A due to the use of integer units used in the representation of the inverse of the target rate in FIGS. 3B-10B.

As shown in FIG. 2A, process 200 can start at Block 202, by initializing all of the request rate governors 110a-b in a processing system, e.g., request rate governors 110a-b of FIG. 1. The initialization in Block 202 can involve setting all request rate governors 110a-b to generate either a maximum target request rate in the case of proportional share weight βᵢ, the maximum target request rate referred to as “RateMAX” (and correspondingly, index “N” may be initialized to “1”), or a minimum period in the case of proportional share stride αᵢ, referred to as periodMIN, which may also be initialized to 1. Initialization Block 252 in process 250 of FIG. 2B may be similar with the initialization conditions as shown in FIG. 2C, with the difference that with respect to stride, the target is StrideMin as shown in FIG. 2C, rather than RateMax.

In FIG. 2A, upon initialization at Block 202, process 200 can proceed to Block 204 comprising a first phase referred to as a “Rapid Throttle” phase. In Block 204, a new target rate for governors 110 is set wherein upper and lower bounds for the target rate in the Rapid Throttle phase are also established. In an example, the target rate for each of request rate governor 110a-b can be reset to the maximum target rate, RateMAX, and then the target rate may be decreased over several iterations until the saturation signal SAT from saturation monitor 108 indicates that there is no saturation in memory controller 106. To maintain the proportional share of bandwidth allocation among private caches 104a-b comprising the respective request rate governors 110a-b, during the Rapid Throttle phase in Block 204, each of request rate governors 110a-b can scale its respective target rate based on its corresponding assigned βᵢ value, and the target rate can be decreased by step sizes that decrease exponentially from iteration to iteration. For example, the magnitude of the decreases may be according to Equation (2) below:

$$Rate = \frac{RateMAX}{N} * {β}_{i} \qquad Equation ( 2 )$$

(Equivalently in terms of stride, the Equation 2 can be represented as Equation (2′):

Stride=N*αᵢ Equation(2′))

In one aspect, the upper bound and lower bound that each of request rate governors 110a-b obtains for its new target rate can be the last two target rates in the iterative decreasing of the target rate. As an illustration, assuming an n^{th} iteration of the Rapid Throttle phase in Block 204 results in memory controller 106 being unsaturated, the target rate at the previous (n−1)^{th} iteration can be set as the upper bound and the target rate at the n^{th} iteration can be set as the lower bound. Example operations in the Rapid Throttle phase of Block 204 are described in FIGS. 3A-4A and example operations in the counterpart Rapid Throttle phase of Block 254 are described in FIGS. 3B-4B.

Once the upper bound and lower bounds are established in Block 204, process 200 can proceed to Block 206 comprising a second phase, referred to as the “Fast Recovery” phase. In the Fast Recovery phase the target rates generated by each of request rate governors 110a-b is quickly refined, e.g., using a binary search process, to a target rate which falls within the upper bound and lower bound, and has the highest value at which the saturation signal SAT from saturation monitor 108 does not indicate saturation. The binary search process may, at each iteration, change the target rate in a direction (i.e., up or down) based on whether the previous iteration resulted in (or removed) saturation of memory controller 106. In this regard, the pair of Equations (3) below may be applied if the previous iteration resulted in saturation of memory controller 106, and Equation (4) below may be applied if the previous iteration resulted in an unsaturated state of memory controller 106:

PrevRate=Rate; and Rate=Rate−(PrevRate−Rate) Equations (3)

Rate=0.5*(Rate+PrevRate) Equation (4)

(Equivalently, the counterpart Equations (3′) and (4′) are provided when stride is used instead of rate as shown in algorithm 650 of FIG. 6B)

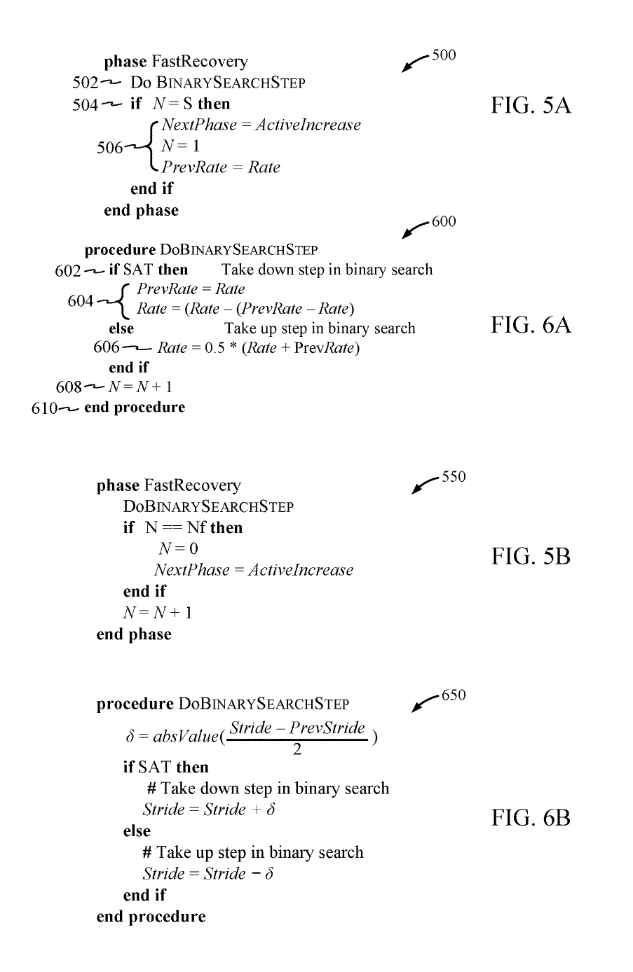

In an aspect, operations at Block 206 can be closed ended, i.e., request rate governors 110a-b can exit the Fast Recovery phase after a particular number “S” (e.g., 5) number of iterations in the binary search are performed. Examples of operations at 206 in the Fast Recovery phase are described in greater detail with reference to FIGS. 5A-6A below and example operations at Block 256 of FIG. 2B are shown in counterpart FIGS. 5B-6B.

Referring to FIG. 2A, upon the Fast Recovery operations at 206 applying the S^{th} iteration of refining the new target rate, each one of request rate governors 110a-b will have a target rate that, for current system conditions, properly apportions the system bandwidth (e.g., of memory controller 106 which controls the bandwidth of interface 114 and memory 112 in FIG. 1) among private caches 104a-b. However, system conditions can change. For example, additional agents such as private caches of other processors (not visible in FIG. 1) may vie for access to the shared memory 112 via memory controller 106. Alternatively, or additionally, one or both of processors 102a-b or their respective private caches 104a-b may be assigned to a new QoS class with a new QoS value.

Therefore, in an aspect, upon the Fast Recovery operations at 206 refining the target rates for governors 110a-b, process 200 can proceed to Block 208 comprising a third phase which may also be referred to as the “Active Increase” phase. In the Active Increase phase request rate governors 110a-b may seek to determine if more memory bandwidth has become available. In this regard, the Active Increase phase can include a step-wise increase in the target rate, at each of request rate governors 110a-b, which may be repeated until the saturation signal SAT from saturation monitor 108 indicates saturation of memory controller 106. Each iteration of the step-wise increase can enlarge the magnitude of the step. For example, the magnitude of the step may be increased exponentially, as defined by Equation (5) below, wherein N is an iteration number, starting at N=1

Rate=Rate+(βᵢ*N) Equation (5)
(Or equivalently, in terms of Stride, Equation (5′) may be used:

Stride=Stride−αᵢ*N Equation (5′))

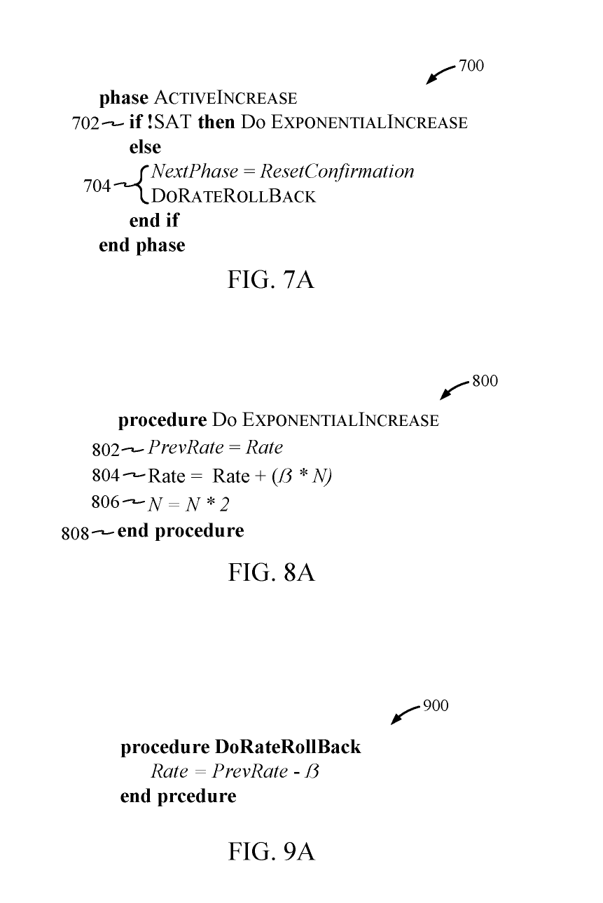

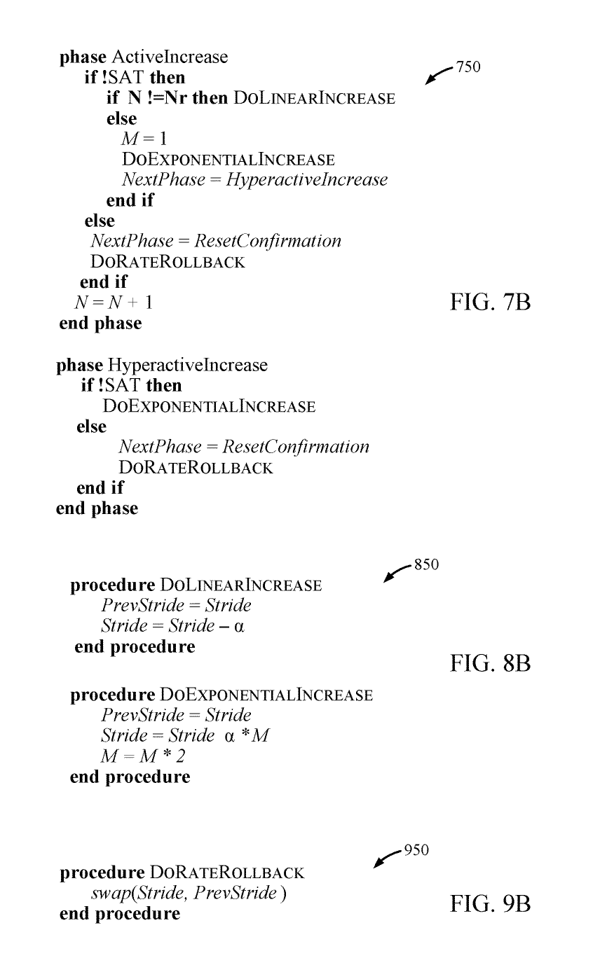

Examples of operations at Block 208 in the Active Increase phase are described in greater detail in reference to FIGS. 7A-9A. In FIG. 2B, Blocks 258 and 259 are shown as counterparts of Block 208 of FIG. 2A. In more detail, the Active Increase phase is split into two phases: the Active Increase phase of Block 258 which increases linearly and the Hyperactive Increase phase of Block 259 which increases exponentially. Correspondingly, FIGS. 7B-9B provide greater details for both Blocks 258 and 259 of FIG. 2B.

With reference to FIG. 2A, in some cases, request rate governors 110a-b may be configured such that, in response to the first instance that the Active Increase operations at Block 208 result in the saturation signal SAT indicating saturation, process 200 can immediately proceed to the Rapid Throttle operations at 204.

However, in an aspect, to provide increased stability, process 200 can first proceed to Block 210 comprising a fourth phase referred to as a “Reset Confirmation” phase to confirm that the saturation signal SAT which caused the exit from the Active Increase phase in Block 208 was likely due to a material change in conditions, as opposed to a spike or other transient event. Stated differently, operations in the Reset Confirmation phase in Block 210 can provide a qualification of the saturation signal SAT as being non-transient, and if confirmed, i.e., if the qualification of the saturation signal SAT as being non-transient is determined to be true in Block 210, then process 200 follows the “yes” path to Block 212 referred to as a “Reset” phase, and then returns to operations in the Rapid Throttle phase in Block 204. In an aspect the Active Increase phase operations in Block 208 can also be configured to step down the target rate by one increment when exiting to the Reset Confirmation phase operations in Block 210. One example step down may be according to Equation (6) below:

Rate=PrevRate−βᵢ Equation (6)
(Equivalently, in terms of stride, Equation (6′) applies:

Stride=PrevStride+αᵢ Equation (6′))

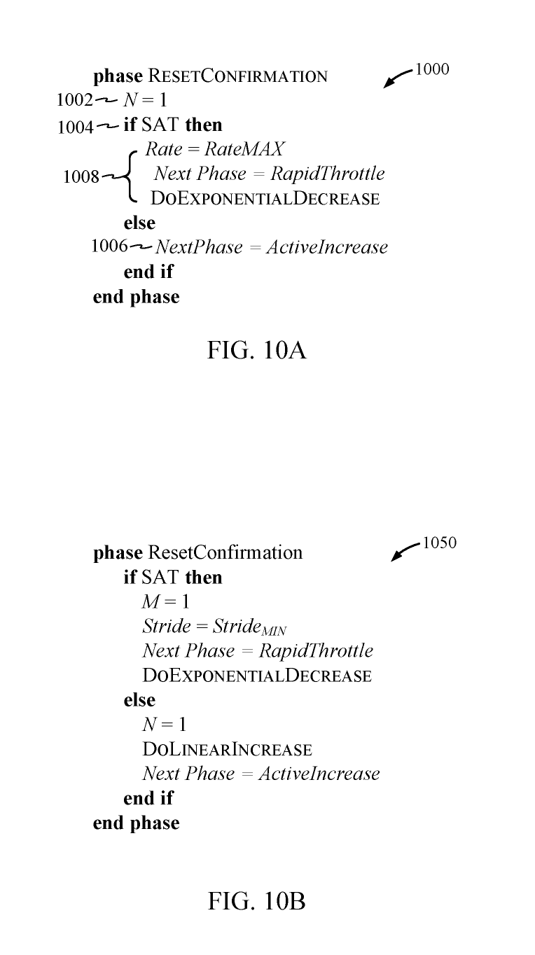

In an aspect, if operations in the Reset Confirmation phase at Block 210 indicate that the saturation signal SAT which caused the exit from the Active Increase phase operations in Block 208 was due to a spike or other transient event, process 200 may return to the Active Increase operations in Block 208. Corresponding Reset Confirmation phase at Block 260 is shown in FIG. 2B and FIG. 10B.

FIG. 3A-B show pseudo code algorithms 300 and 350, respectively, for example operations that may implement the Rapid Throttling phase in Block 204 of FIG. 2A and Block 254 of FIG. 2B. FIGS. 4A-B show pseudo code algorithms 400 and 450 that may implement the exponential decrease procedure labeled “ExponentialDecrease” that is included in the pseudo code algorithms 300 and 350, respectively. The pseudo code algorithm 300 will hereinafter be referenced as the “Rapid Throttle phase algorithm 300,” and the pseudo code algorithm 400 as the “Exponential Decrease algorithm 400” and will be explained in greater detail below, while keeping in mind that similar explanations are applicable to counterpart pseudo code algorithms 350 and 450.

Referring to FIGS. 3A and 4A, example operations in the Rapid Throttle phase algorithm 300 can start at 302 with a conditional branch operation based on SAT from the FIG. 1 saturation monitor 108. If SAT indicates that memory controller 106 is saturated, the pseudo code algorithm 300 can jump to the Exponential Decrease algorithm 400 to decrease the target rate. Referring to FIG. 4A, the Exponential Decrease algorithm 400 can at 402 set PrevRate to Rate, then at 404 can decrease the target rate according to Equation (2), proceed to 406 and multiply N by 2, and then proceed to 408 and return to the Rapid Throttle phase algorithm 300. The Rapid Throttle phase algorithm 300 can repeat the above-described loop, doubling N at each iteration, until the conditional branch at 302 receives SAT at a level indicating the shared memory controller 106 is no longer saturated. The Rapid Throttle phase algorithm 300 can then proceed to 304, where it sets N to 0, then to 306 where it transitions to the FIG. 2A Fast Recovery phase in Block 206.

FIGS. 5A-B show pseudo code algorithms 500 and 550 for example operations that may implement the Fast Recovery phase in Block 206 of FIG. 2A and Block 256 of FIG. 2B, respectively. FIGS. 6A-B show pseudo code algorithms 600 and 650 that may implement the binary search procedure, labeled “BinarySearchStep” that is included in the pseudo code algorithms 500 and 550, respectively. The pseudo code algorithm 500 will hereinafter be referenced as the “Fast Recovery phase algorithm 500” and the pseudo code algorithm 600 as the “Binary Search Step algorithm 600” and will be explained in greater detail below, while keeping in mind that similar explanations are applicable to counterpart pseudo code algorithms 550 and 650.

Referring to FIGS. 5A and 6A, example operations in the Fast Recovery phase algorithm 500 can start at 502 by jumping to the Binary Search Step algorithm 600, which increments N by 1. Upon returning from the Binary Search Step algorithm 600 operations at 504 can test whether N is equal to S, where “S” is a particular number of iterations that the Fast Recovery phase algorithm 500 is configured to repeat. As described above, one example “S” can be 5. Regarding the Binary Search Step algorithm 600, example operations can start at the conditional branch at 602, and then to either the step down operations at 604 or the step up operations at 606, depending on whether SAT indicates that memory controller 106 is saturated. If SAT indicates that memory controller 106 is saturated, the Binary Search Step algorithm 600 can proceed to the step down operations at 604, which decrease the target rate according to Equations (3). The Binary Search Step algorithm 600 can then proceed to 608 to increment N by 1, and then to 610 to return to the Fast Recovery phase algorithm 600.

If at 602 SAT indicates that memory controller 106 is not saturated, the Binary Search Step algorithm 600 can proceed to the step up operation at 606 which increases the target rate according to Equation (4). The Binary Search Step algorithm 600 can then proceed to 608 where it can increment N by 1, then at 610 can return to the Fast Recovery phase algorithm 600. Upon detecting at 504 that N has reached S, the Fast Recovery phase algorithm 500 can proceed to 506, to initialize N to integer 1 and set PrevRate to the last iteration value of Rate, and then jump to the Active Increase phase in Block 208 of FIG. 2A.

FIGS. 7A-B show pseudo code algorithms 700 and 750 for example operations that may implement the Active Increase phase in Block 208 of FIG. 2A and Blocks 258 and 259 of FIG. 2B, respectively. FIG. 8A shows pseudo code algorithm 800 that may implement the target rate increase procedure labeled “ExponentialIncrease” included in the pseudo code algorithm 700. FIG. 8B shows pseudo code algorithm 850 that may implement the target stride setting procedures pertaining to Linear Increase and Exponential Increase included in the pseudo code algorithm 750. FIGS. 9A-B show pseudo code algorithms 900 and 950 that may implement the rate rollback procedure labeled “RateRollBack” also included in the pseudo code algorithms 700 and 750 respectively. The pseudo code algorithm 700 will hereinafter be referenced as the “Active Increase phase algorithm 700,” the pseudo code algorithm 800 will be referenced as the “Exponential Increase algorithm 800,” and the pseudo code algorithm 900 as the “Rate Rollback procedure algorithm 900” and will be explained in greater detail below, while keeping in mind that similar explanations are applicable to counterpart pseudo code algorithms 750, 850, and 950.

Referring to FIGS. 7A, 8A, and 9A, example operations in the Active Increase phase algorithm 700 can start at 702 at the conditional exit branch at 702, which causes an exit to Reset Confirmation phase in Block 210 of FIG. 2A, upon SAT indicating that memory controller 106 is saturated. Assuming at the first instance of 702 that saturation has not occurred, the Active Increase phase algorithm 700 can proceed from 702 to the Exponential Increase algorithm 800.

Referring to FIG. 8A, operations in the Exponential Increase algorithm 800 can at 802 set PrevRate to Rate, then to 804 to increase the target rate according to Equation (5), then at 806 to double the value of N. The Exponential Increase algorithm 800 can then, at 808, return to 702 in the Active Increase phase algorithm 700. The loop from 702 to the Exponential Increase algorithm 800 and back to 702 can continue until SAT indicates that memory control 106 is saturated. The Active Increase phase algorithm 700 can then, in response, proceed to 704 where it can decrease the target rate using the Rate Rollback procedure algorithm 900 and proceed to the Confirmation Reset phase in Block 210 of FIG. 2. Referring to FIG. 9A, the Rate Rollback procedure algorithm 900 can, for example, decrease the Target Rate according to Equation (6).

FIGS. 10A-B show pseudo code algorithms 1000 and 1050 for example operations that may implement the Confirmation Reset phase in Block 210 of FIG. 2A and Block 260 of FIG. 2B, respectively. The pseudo code algorithm 1000 will hereinafter be referenced as the “Confirmation Reset phase algorithm 1000” and explained in greater detail below, while keeping in mind that pseudo code algorithm 1050 is similar. Referring to FIG. 10A, operations in the Confirmation Reset phase algorithm 1000 can start at 1002, where N can be reset to 1. Referring to FIG. 10A together with FIGS. 2A, 3A, 4A and 7A, it will be understood that the integer “1” is the proper starting value of N for entering either of the two process points to which the Confirmation Reset phase algorithm 1000 can exit.

Referring to FIG. 10A, after setting N to the integer 1 at 1002, the Confirmation Reset phase algorithm 1000 can proceed to 1004 to determine, based on the saturation signal SAT from saturation monitor 108, whether the Confirmation Reset phase algorithm 1000 exits to the Rapid Throttle phase in Block 202 (implemented, for example, according to FIGS. 3A, 4A), or to the Active Increase phase in Block 208 (implemented, for example, according to FIGS. 7A, 8A and 9A). More particularly, if at 1004 SAT indicates no saturation then the likely cause of the SAT that caused termination at 702 and exit from the Active Increase phase algorithm 700 may be a transient condition, not warranting a repeat of process 200 of FIG. 2A. Accordingly, the Confirmation Reset phase algorithm 1000 can proceed to 1006 and back to the Active Increase phase algorithm 700. It will be understood that the earlier reset at 702 of N to integer 1 will return the Active Increase phase algorithm 700 to its starting state of increasing the target rate.

Referring to FIG. 10A, if SAT at 1004 indicates saturation of memory controller 106 then the likely cause of the saturation signal SAT that resulted in the exit at 702 from the Active Increase phase algorithm 700 was a substantive change in memory load, for example, another private cache accessing memory controller 106, or a re-assignment of QoS values. Accordingly, the Confirmation Reset phase algorithm 1000 can proceed to 1008 where operations can reset the target rate to RateMAX (or in the case of pseudo code algorithm 1050, reset the stride to StrideMin) and then to the Exponential Decrease algorithm 400 and then return to the Rapid Throttle phase algorithm 300.

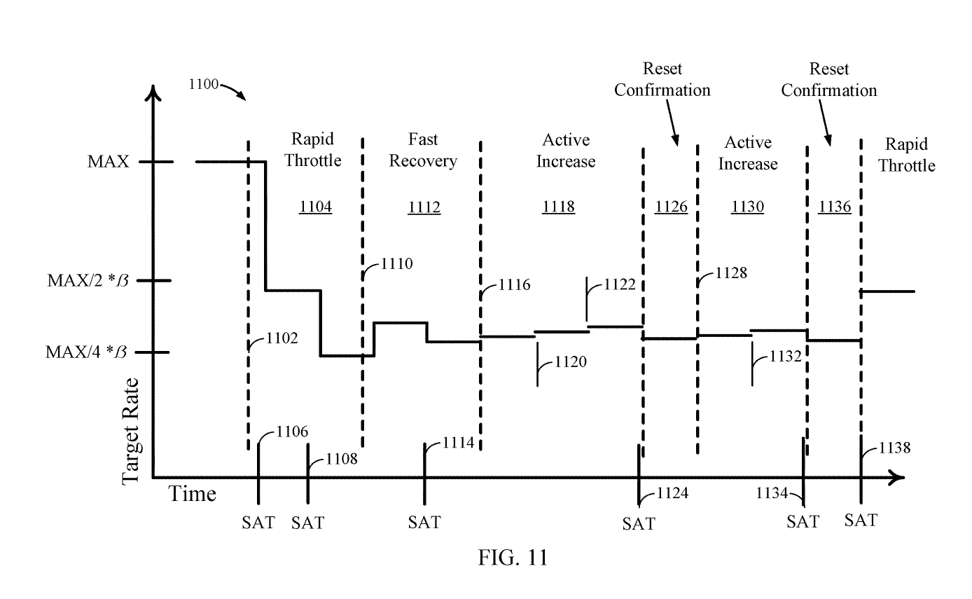

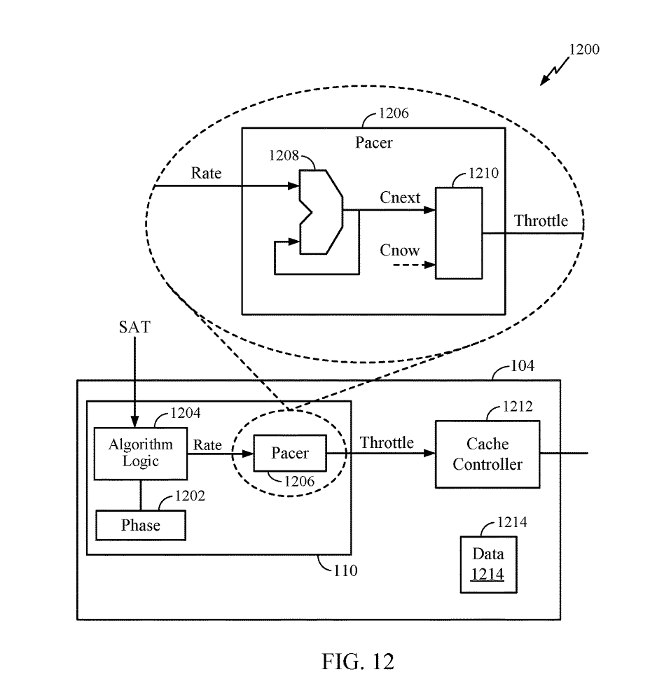

FIG. 11 shows a timing simulation of events in a multiple phase throttling process in a proportional bandwidth allocation according to aspects of this disclosure. The horizontal axis represents time demarked in epochs. The vertical axis represents the target rate. It will be understood that β represents βᵢ at the different request rate governors 110. Events will be described in reference to FIGS. 1 and 2A-B. The saturation signal “SAT” indicated on the horizontal or time axis represent a value SAT from saturation monitor 108 indicating saturation. Absence of SAT at an epoch boundary represents SAT from the saturation monitor indicating no saturation.

Referring to FIG. 11, prior to epoch boundary 1102 the target rate of all request rate governors 110 is set to RateMAX (or correspondingly to StrideMin) and N is initialized at 1. At epoch boundary 1102 all request rate governors 110 transition to the Rapid Throttle phase in Block 202. The interval over which request rate governors 110a-bremain in the Rapid Throttle phase in Block 202 is labeled 1104 and will be referred to as the “Rapid Throttle phase 1104.” Example operations over the Rapid Throttle phase 1104 will be described in reference to FIGS. 3A and 4A. The saturation signal SAT is absent at epoch boundary 1102 but, as shown in FIG. 4A, item 406, N (which was initialized to “1”) is doubled such that N=2. Upon receiving SAT 1106 at a next epoch boundary (not separately labeled) request rate governors 110a-b decrease their respective target rates with N=2, as shown at FIG. 4A, pseudo code operation 404. Accordingly the target rate is decreased to RateMAX/2*β. N is also doubled again, such that N=4. SAT 1108 is received at a next epoch boundary (not separately labeled), and in response request rate governors 110a-b decrease their respective target rates according to Equation (2), with N=4. Accordingly the target rate is decreased to RateMAX/4*β.

At epoch boundary 1110, SAT is absent. A result, as shown by 304 and 306 in FIG. 3A, is that all the request rate governors 110 re-initialize N to “0”, and transition to Fast Recovery phase operations at Block 204. The interval over which request rate governors 110 remain in the Fast Recovery phase is labeled on FIG. 11 as 1112, and will be referred to as the “Fast Recovery phase 1112.” Example operations over the Fast Recovery phase 1112 will be described in reference to FIGS. 5A and 6A. Since SAT was absent at the transition to Fast Recovery phase 1112 a first iteration can increase the target rate by a step up, as shown at FIG. 6A, pseudo code operations 602 and 606. The pseudo code operation 606 increases the target rate to halfway between RateMAX/4*β and RateMAX/2*β. The pseudo code operation 608 increments N to “1”. Upon receiving SAT 1114 at a next epoch boundary (not separately labeled) request rate governors 110a-b decrease their respective target rates according to the FIG. 6A pseudo code operation 604.

Referring to FIG. 11, at epoch boundary 1116 the iteration counter at FIG. 5A item, 504 is assumed to reach “S.” Therefore, as shown at FIG. 5A pseudocode operations 506, N is re-initialized to “1”, PrevRate is set equal to Rate and request rate governors 110a-b transition to Active Increase phase operations at Block 208. The interval following epoch boundary 1116 over which request rate governors 110a-b remain in the Active Increase phase operations be referred to as the “Active Increase phase 1118.” Example operations over the Active Increase phase 1118 will be described in reference to FIGS. 7A, 8A and 9A. At the epoch boundary 1116 a first iteration in the Active Increase phase 1118 increases the target rate by the FIG. 8A pseudo code operation 804, or as defined by Equation (5). At the epoch boundary 1120 a second iteration increases the target rate again by the FIG. 8A pseudo code operation at 804. At the epoch boundary 1122 a third iteration again increases the target rate by the FIG. 8A pseudo code operation 804.

At the epoch boundary 1124, SAT appears and, in response, the request rate governors 110 transition to the Rest Confirmation operations in Block 210 of FIG. 2A. The transition can include a step down of the target rate, as shown at FIG. 7A, pseudo code operation 704. The interval following epoch boundary 1124 over which the request rate governors 110 remain in the FIG. 2A Reset Confirmation phase operations at 210 will be referred to as the “Reset Confirmation phase 1126.” At epoch boundary 1128 SAT is absent, which means the SAT that caused the transition to the Reset Confirmation phase 1126 was likely a transient or spike event. Accordingly the response, the request rate governors 110 transition back to the FIG. 2A Active Increase operations at 208.

The interval following epoch boundary 1128 over which request rate governors 110a-b again remain in the Active Increase phase operations at Block 208 be referred to as the “Active Increase phase 1130.” Example operations over the Active Increase phase 1130 will again be described in reference to FIGS. 7A, 8A and 9A. When the request rate governors 110 transitioned to the Active Increase phase 1128, a first iteration in the Active Increase phase 1130 increased the target rate by the FIG. 8A pseudo code operation 804, as defined by Equation (5). At epoch boundary 1132, since SAT is absent a second iteration again increases the target rate by the FIG. 8A pseudo code operation 804.

At the epoch boundary 1134, SAT appears and, in response, the request rate governors 110 again transition to the FIG. 2A Rest Confirmation operations 210. The transition can include a step down of the target rate, as shown at FIG. 7A, pseudo code operation 704. The interval following epoch boundary 1134 over which request rate governors 110a-b remain in the Reset Confirmation phase operations at Block 210 will be referred to as the “Reset Confirmation phase 1136.” At epoch boundary 1138 SAT is received, which means the SAT that caused the transition to the Reset Confirmation phase 1126 was likely change in system conditions. Accordingly, request rate governors 110a-b transition to the Rapid Throttle operations at Block 202.

Referring to FIG. 1, request rate governors 110a-b can enforce the target rate by spreading out in time the misses (and corresponding accesses of memory controller 106) by private caches 104a-b. To achieve a rate R, request rate governors 110a-b can be configured to restrict private caches 104a-b so that each issues a miss, on average, every W/Rate cycles. Request rate governors 110a-b can be configured to track the next cycle in which a miss is allowed to issue, Cnext. The configuration can include preventing private caches 104a-b from issuing a miss to memory controller 106 if the current time, Cnow, is less than Cnext. Request rate governors 110a-b can be further such that once a miss is issued Cnext can be updated to Cnext+(W/Rate). It will be understood that within a given epoch, W/Rate is a constant. Therefore, rate enforcement logic can be implemented using a single adder.

It will be understood that within an epoch, controlled rate caches, such as the private caches 102, can be given “credit” for brief periods of inactivity, since Cnext can be strictly additive. Accordingly, if a private cache 104a-b goes through a period of inactivity such that Cnow>>Cnext, that private cache 104a-b can be allowed to issue a burst of requests without any throttling while Cnext catches up. Request rate governors 110a-b can be configured such that, at the end of each epoch, Cnext can be set equal to Cnow. In another implementation, request rate governors 110a-b can be configured such that at the end of each epoch boundary, adjusting C_Next can be adjusted by N*(difference in Stride, PrevStride), which makes it appear as if the prior N (e.g., 16) requests were issued at the new stride/rate rather than the old stride/rate. These features can provide a certainty that any built up credit from the previous epoch does not spill in to the new epoch.

FIG. 12 shows a schematic block diagram 1200 of one arrangement of logic that can form each of private caches 104a-b (designated with reference label “104” in this view) and its corresponding request rate governor 110a-b (designated with reference label “110” in this view). As described above, request rate governor 110 can be configured to provide functions of determining the target rate that private cache 104 can issue requests to memory controller 106, given the sharing parameter βᵢ that is assigned, and to provide throttling of private cache 104 according to that target rate. Referring to FIG. 12, example logic providing request rate governor 110 can include phase state register 1202 or equivalent and algorithm logic 1204. In an aspect, phase state register 1202 can be configured to indicate the current phase of the request rate governor 110 among the four phases described in reference to FIGS. 2-10. Phase state register 1202 and algorithm logic 1204 can be configured to provide functions of determining the target rate, based on the QoS and βᵢ assigned to request rate governor 110.

In some aspects, pacer 1206 may be provided to allow a slack in the target rate enforced. The slack allows each requesting agent or class to build up a form of credit during idle periods when requests are not sent by the requesting agents. The requesting agents can later, e.g., in a future time window, use the accumulated slack to generate a burst of traffic or requests for access which would still meet the target rate. In this manner, the requesting agents may be allowed to send out bursts, which can lead to performance improvements. Pacer 1206 may enforce the target request rate by determining bandwidth usage over time windows or periods of time which are inversely proportional to the target request rate. Unused accumulated bandwidth from a previous period of time can be used in a current period of time to allow a burst of one or more requests even if the burst causes the request rate in the current period of time to exceed the target request rate.

In some aspect, pacer 1206 can be configured to provide throttling of private cache 102 according to that target request rate as discussed above. In an aspect, algorithm logic 1204 can be configured to receive SAT from saturation monitor 108, and perform each of the four phase processes described in reference to FIGS. 2-10 as well as generate as an output the target rate. In an aspect, algorithm logic 1204 can be configured to receive a reset signal to align the phases of all of the request rate governors 110.

Referring to FIG. 12, pacer 1206 can include adder 1208 and miss enabler logic 1210. Adder 1208 can be configured to receive the target rate (labeled “Rate” in FIG. 12), from algorithm logic 1204 and perform addition such that once a miss is issued Cnext can be updated to Cnext+(W/Rate), (or to Cnext+Stride, in terms of stride). Miss enabler logic 1210 can be configured to prevent private cache 104 from issuing a miss to memory controller 106 if the current time, Cnow, is less than Cnext.

The FIG. 12 logic can include cache controller 1212 and cache data storage 1214. Cache data storage 1214 can be according to known, conventional techniques for cache data storage, therefore further detailed description is omitted. Cache controller 1212, other than being throttled by pacer 1206, can be according to known, conventional techniques for controlling a cache, and therefore further detailed description is omitted.

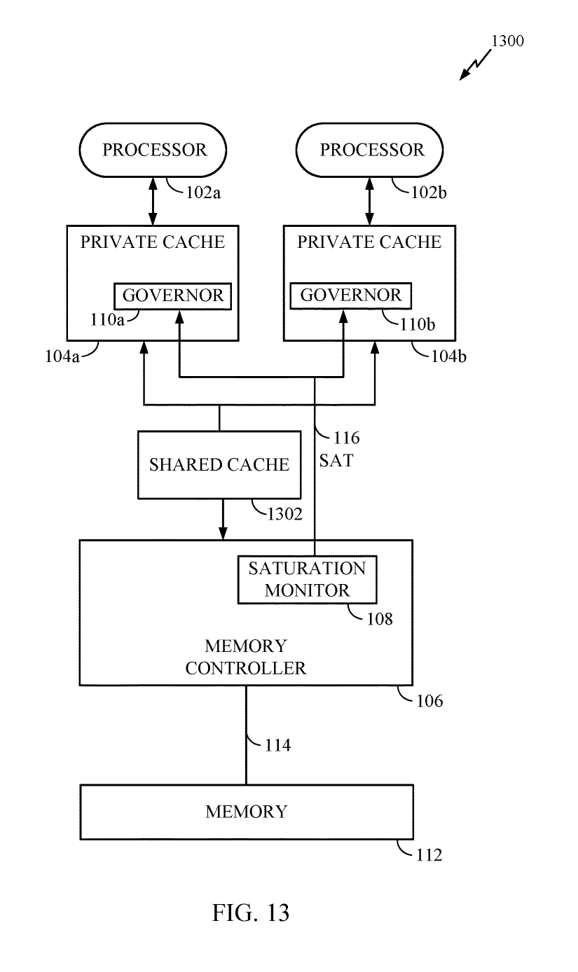

FIG. 13 shows one configuration of a proportional bandwidth allocation system 1300, including shared second level cache 1302 (e.g., a level 2 or “L2” cache), in one exemplary arrangement according to aspects of this disclosure.

Referring to FIG. 13, the rate governed components, namely private caches 104a-b send requests to shared cache 1302. Accordingly, in an aspect features can be included that provide that the target rates determined by request rate governors 110a-b translate into the same bandwidth share at memory controller 106. The features, according to the aspect, can adjust the target rates to account for accesses from the private caches 104a-b that do not reach memory controller 106 due to being hits in shared cache 1302. Thus, the target rate for the private caches 104a-b may be obtained by filtering, at shared cache 1302, misses from the private caches 104, such that memory controller 106 receives the filtered misses from shared cache 1302, and the target rate at private caches 104a-b may correspondingly be adjusted based on the filtered misses.

For example, in one aspect, a scaling feature may be provided, configured to scale the target rate by the ratio between a miss rate of private caches 104a-b and a miss rate of shared cache 1302 for requests generated by processors 102a-b. The ratio can be expressed as follows:
Let M_{p,i} be the miss rate of requests in the i^{th} private cache 104a-b (e.g., i=1 for private cache 104a and i=2 for private cache 104b).
Let M_{s,j} be the miss rate for requests from the i^{th} processor 102a-b requests in shared cache 1302. The final target rate enforced by request rate governors 110a-b can be represented as:

$$\frac{{M}_{p , i}}{{M}_{s , i}} * Rate \qquad Equation ( 7 )$$

In an aspect, the rate can be expressed as the number of requests issued over a fixed window of time, which can be arbitrarily termed “W.” In an aspect W can be set to be the latency of a memory request when the bandwidth of memory controller 106 is saturated. Accordingly, saturation RateMAX can be equal to the maximum number of requests that can be concurrently outstanding from a private cache 104a-b. The number, as is known in the related art, can be equal to the number of Miss Status Holding Registers (MSHRs) (not separately visible in FIG. 1).

Referring to FIG. 13, in an alternative implementation using strides rather than the rate-based calculation in Equation (7), Cnext can be adjusted to Cnext=Cnext+Stride for all requests leaving private caches 104a-b. If it is subsequently determined that the requests were serviced by shared cache 1304, then any associated penalty of adjusting Cnext=Cnext+Stride can be reversed. Similarly, for any write-backs from shared cache 1304 to memory 112 (e.g., that occur when a line is replaced in shared cache 1304), Cnext can be adjusted as Cnext=Cnext+Stride when, on receiving a response from memory 112, it is determined that the request caused the write-back to occur. The effect of Cnext adjustment in this manner is equivalent to the scaling of Equation (7) over the long run and is referred to as shared cache filtering. Furthermore, by using stride rather than rate, use of the W term discussed above can be avoided.

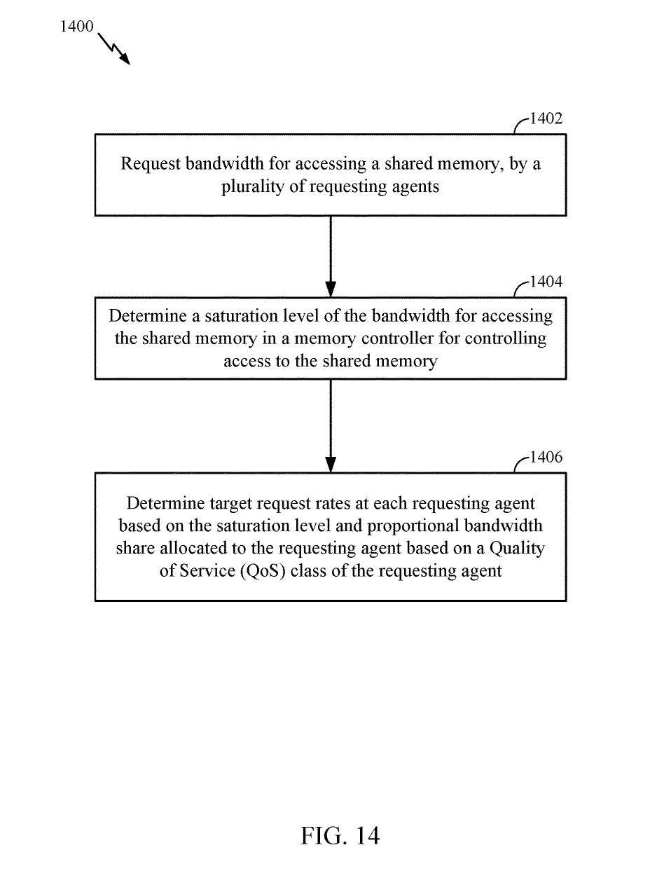

Accordingly, it will be appreciated that exemplary aspects include various methods for performing the processes, functions and/or algorithms disclosed herein. For example, FIG. 14 illustrates a method 1400 for distributed allocation of bandwidth.

Block 1402 comprises requesting, by a plurality of requesting agents (e.g., private caches 104a-b), bandwidth for accessing a shared memory (e.g., memory 112).

Block 1404 comprises determining a saturation level (saturation signal SAT) of bandwidth for accessing the shared memory in a memory controller (e.g., memory controller 106) for controlling access to the shared memory (e.g., based on count of a number of outstanding requests which are not scheduled access to the shared memory due to unavailability of the bandwidth for access to the shared memory).

Block 1406 comprises determining target request rates at each requesting agent (e.g., at request rate governors 110a-b) based on the saturation level and proportional bandwidth share allocated to the requesting agent based on a Quality of Service (QoS) class of the requesting agent. For example, the saturation level can indicate one of an unsaturated state, low saturation, medium saturation, or high saturation. In some aspects, the proportional bandwidth share for each requesting agent is provided by a bandwidth share weight assigned to the requesting agent divided by a sum of the bandwidth share weights assigned to each of the plurality of requesting agents, while in some aspects, the proportional bandwidth share for each requesting agent is provided by a bandwidth share stride assigned to the requesting agent multiplied by a sum of the bandwidth share strides assigned to each of the plurality of requesting agents. Further, method 400 can also comprise throttling issuance of requests from a requesting agent for access to the shared memory, for enforcing the target request rate at the requesting agent, and the saturation level may be determined at epoch boundaries, as discussed above.

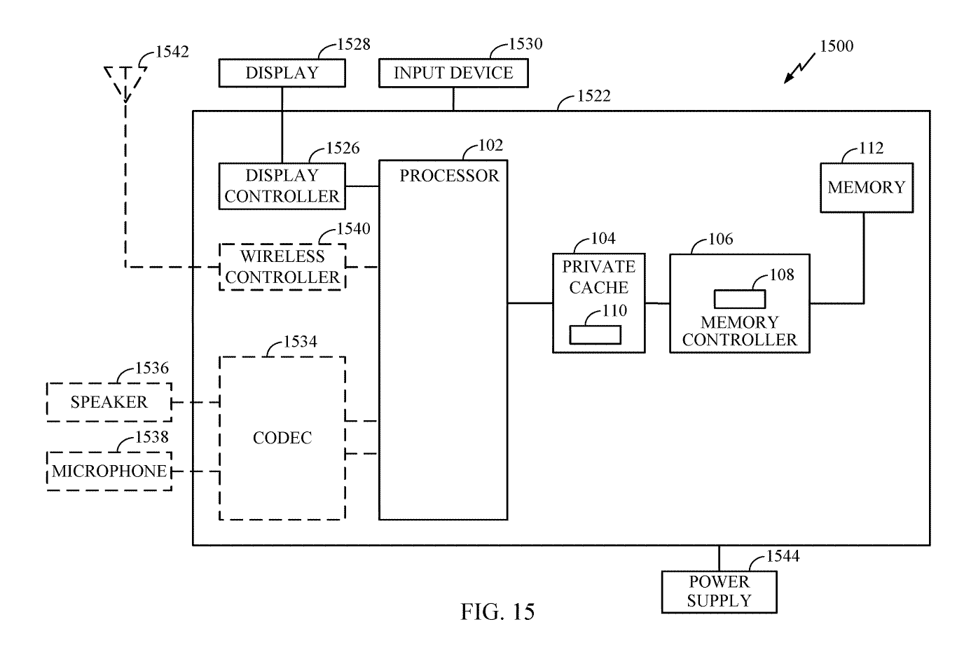

FIG. 15 illustrates computing device 1500 in which one or more aspects of the disclosure may be advantageously employed. Referring now to FIG. 15, computing device 1500 includes a processor such as processors 102a-b (shown as processor 102 in this view) coupled to private cache 104 comprising request rate governor 110 and to memory controller 106 comprising saturation monitor 108 as previously discussed. Memory controller 106 may be coupled to memory 112, also shown.

FIG. 15 also shows display controller 1526 that is coupled to processor 102 and to display 1528. FIG. 15 also shows some blocks in dashed lines which are optional, such as coder/decoder (CODEC) 1534 (e.g., an audio and/or voice CODEC) coupled to processor 1502, with speaker 1536 and microphone 1538 coupled to CODEC 1534; and wireless controller 1540 coupled to processor 102 and also to wireless antenna 1542. In a particular aspect, processor 102, display controller 1526, memory 112, and where present, CODEC 1034, and wireless controller 1540 may be included in a system-in-package or system-on-chip device 1522.

In a particular aspect, input device 1530 and power supply 1544 can be coupled to the system-on-chip device 1522. Moreover, in a particular aspect, as illustrated in FIG. 15, display 1528, input device 1530, speaker 1536, microphone 1538, wireless antenna 1542, and power supply 1544 are external to the system-on-chip device 1522. However, each of display 1528, input device 1530, speaker 1536, microphone 1538, wireless antenna 1542, and power supply 1544 can be coupled to a component of the system-on-chip device 1522, such as an interface or a controller.

It will be understood that the proportional bandwidth allocation according to exemplary aspects, and as shown in FIG. 14 may be executed by computing device 1500. It should also be noted that although FIG. 15 depicts a computing device, processor 102 and memory 112 may also be integrated into a set-top box, a music player, a video player, an entertainment unit, a navigation device, a personal digital assistant (PDA), a fixed location data unit, a computer, a laptop, a tablet, a server, a mobile phone, or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer readable media embodying a method for bandwidth allocation of shared memory in a processing system. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method distributed allocation of bandwidth, the method comprising:
requesting, by a plurality of requesting agents, bandwidth for accessing a shared memory;
determining a saturation level of the bandwidth for accessing the shared memory in a memory controller for controlling access to the shared memory; and
determining target request rates at each requesting agent based on the saturation level and proportional bandwidth share allocated to the requesting agent based on a Quality of Service (QoS) class of the requesting agent.

2. The method of claim 1, comprising determining the saturation level at a saturation monitor implemented in the memory controller, wherein the saturation level is based on a count of a number of outstanding requests which are not scheduled access to the shared memory due to unavailability of the bandwidth for access to the shared memory.

3. The method of claim 2, wherein the saturation level indicates one of an unsaturated state, low saturation, medium saturation, or high saturation.

4. The method of claim 1, comprising determining the target request rate for a requesting agent at a request rate governor implemented in the requesting agent.

5. The method of claim 4, further comprising increasing or decreasing the target request rate to a new target request rate, based on a direction determined from the saturation level.
determining an upper bound and a lower bound for a new target request rate,
refining the new target request rate by at least one step, the at least one step being in a direction based at least in part on the saturation level, and
if the saturation level exceeds a threshold, then, upon confirming the saturation level meets a qualification of being non-transient, initializing the target request rate.

6. The method of claim 5, further comprising
adjusting the target request rate at each requesting agent to be the new target request rate.

7. The method of claim 6, further comprising:
if the saturation level does not meet a qualification of being non-transient at the new target request rate, increasing or decreasing the target request rate until the saturation level exceeds a threshold.

8. The method of claim 7, further comprising:
if the saturation level meets a qualification of being non-transient at the new target request rate, initializing the target request rate and adjusting the target request rate to be the new target rate at each requesting agent, in synchronized lock step.

9. The method of claim 1, wherein the proportional bandwidth share for each requesting agent is provided by a bandwidth share weight assigned to the requesting agent divided by a sum of the bandwidth share weights assigned to each of the plurality of requesting agents.

10. The method of claim 1, wherein the proportional bandwidth share for each requesting agent is provided by a bandwidth share stride assigned to the requesting agent multiplied by a sum of the bandwidth share strides assigned to each of the plurality of requesting agents.

11. The method of claim 1, wherein the requesting agents are private caches, each private cache receiving requests for accessing the shared memory from a corresponding processing unit.

12. The method of claim 11, further comprising:
filtering, at a shared cache, misses from the private caches;
receiving, at the memory controller, filtered misses from the shared cache;
adjusting the target request rate at the private caches based on the filtered misses.

13. The method of claim 1, further comprising throttling issuance of requests from a requesting agent for access to the shared memory, for enforcing the target request rate at the requesting agent.

14. The method of claim 1, comprising determining the saturation level at epoch boundaries.

15. The method of claim 1, further comprising determining, in a pacer, unused bandwidth allocated to a requesting agent in a previous period of time and allowing the requesting agent a request rate higher than the target request rate during a current period of time, the higher request rate based on the unused bandwidth.

16. The method of claim 15, wherein the previous and current periods of time are inversely proportional to the target request rate.

17. An apparatus comprising:
a shared memory;
a plurality of requesting agents configured to request access to the shared memory;
a memory controller configured to control access to the shared memory, wherein the memory controller comprises a saturation monitor configured to determine a saturation level of bandwidth for access to the shared memory; and
a request rate governor configured to determine a target request rate at each requesting agent based on the saturation level and a proportional bandwidth share allocated to the requesting agent based on a Quality of Service (QoS) class of the requesting agent.

18. The apparatus of claim 17, wherein the saturation monitor is configured to determine the saturation level based on a count of a number of outstanding requests which are not scheduled access to the shared memory due to unavailability of the bandwidth for access to the shared memory.

19. The apparatus of claim 18, wherein the saturation level indicates one of an unsaturated state, low saturation, medium saturation, or high saturation.

20. The apparatus of claim 17, wherein the proportional bandwidth share for each requesting agent is provided by a bandwidth share weight assigned to the requesting agent divided by a sum of the bandwidth share weights assigned to each of the plurality of requesting agents.

21. The apparatus of claim 17, wherein the proportional bandwidth share for each requesting agent is provided by a bandwidth share stride assigned to the requesting agent multiplied by a sum of the bandwidth share strides assigned to each of the plurality of requesting agents.

22. The apparatus of claim 17, wherein the requesting agents are private caches, each private cache configured to receive requests for access to the shared memory from a corresponding processing unit.

23. The apparatus of claim 17, wherein the request rate governor is configured to throttle issuance of requests to the shared memory from the corresponding requesting agent to enforce the target rate at the corresponding requesting agent.

24. The apparatus of claim 17, wherein the saturation monitor is configured to determine the saturation level at epoch boundaries.

25. The apparatus of claim 17, integrated into a device selected from the group consisting of a set top box, music player, video player, entertainment unit, navigation device, communications device, personal digital assistant (PDA), fixed location data unit, a server, and a computer.

26. An apparatus comprising:
means requesting bandwidth for accessing a shared memory;
means for controlling access to the shared memory comprising means for determining a saturation level of the bandwidth for accessing the shared memory; and
means for determining a target request rate at each means for requesting based on the saturation level and a proportional bandwidth share allocated to the means for requesting agent based on a Quality of Service (QoS) class of the means for requesting.

27. The apparatus of claim 26, wherein the saturation level is based on a count of a number of outstanding requests which are not scheduled access to the shared memory due to unavailability of the bandwidth for access to the shared memory.

28. The apparatus of claim 26, wherein the saturation level indicates one of an unsaturated state, low saturation, medium saturation, or high saturation.

29. A non-transitory computer readable storage medium comprising code, which, when executed by a processor, cause the processor to perform operations for distributed allocation of bandwidth, the non-transitory computer readable storage medium comprising:
code for requesting bandwidth for accessing a shared memory, by a plurality of requesting agents;
code for determining a saturation level of the bandwidth for accessing the shared memory, at a memory controller for controlling access to the shared memory; and
code for determining target request rates at each requesting agent based on the saturation level and proportional bandwidth share allocated to the requesting agent based on a Quality of Service (QoS) class of the requesting agent.

30. The non-transitory computer readable storage medium of claim 29, further comprising code for throttling issuance of requests to the shared memory from the corresponding requesting agents.
